(19) United States
(12) Patent Application Publication
(10) Pub. No.: US 2014/0274258 A1
(43) Pub. Date: Sep. 18, 2014

(54) GAME ALLOCATION SYSTEM FOR PROTECTING PLAYERS IN SKILL-BASED ONLINE AND MOBILE NETWORKED GAMES

(71) Applicant: PartyGaming IA Limited, Hamilton (BM)

(72) Inventors: Andreas Hartmann, Gibraltar (GI); Sateesh Kumar Narsingoju, Hyderabad (IN); Neil Hussey, Gibraltar (GI); Jiri Pallas, Stockholm (SE)

(73) Assignee: PartyGaming IA Limited, Hamilton (BM)

(21) Appl. No.: 14/191,724

(22) Filed: Feb. 27, 2014

Related U.S. Application Data
(60) Provisional application No. 61/799,946, filed on Mar. 15, 2013.

(51) Int. Cl. G07F 17/32

(52) U.S. Cl. CPC G07F 17/3227; G07F 17/3293
USPC 463/13; 463/23

(57) ABSTRACT

A system for controlling access to a plurality of games in a skill-based electronic game with (1) an electronic data warehouse server configured to determine a game skill level value of a player in the skill-based electronic game network in accordance with predetermined criteria including game play history, and to (a) store a player protection classification value for the at least one player, and (b) store an access protection classification value for at least one of the plurality of games, the game access protection classification value for the at least one game; and (2) an electronic game server configured to allow or deny the player electronic access to the at least one game based upon a comparison of that player's player protection classification value and the game access protection classification value of the at least one game.

### RELATED APPLICATION DATA

This application is a non-provisional filing of U.S. Patent Application No. 61/799,946 filed Mar. 15, 2013, the entirety of which is incorporated herein by reference to the extent permitted by law.

### BACKGROUND OF THE INVENTION

The present invention generally is directed to networked gaming systems. More particularly, the invention is directed to networked gaming systems accommodating differently categorized players.

Several categories of networked gaming systems are well known in the prior art. A networked gaming system may be a web-based java application, like Yahoo! Games. Further, a networked gaming system may be in the form of a downloadable software application that has a unique graphical user interface and may connect to the Internet via the back end of the software, like, for example, the PartyPoker.com client application. Even further, a networked gaming system may be in the form of a networked video game console wherein the several players in a game are connected to a network through their video came console (e.g., XBOX, PS3 and GAMECUBE consoles). Other categories of networked gaming systems are apparent to those persons having ordinary skill in the art, including online and mobile networked gaming systems and networked tablet gaming systems. The game allocation system is designed to work with all such networked gaming systems hosting games involving skill or proficiency.

A player (or user) connected to a networked gaming system may choose to play one or more of the available games. In some networked gaming-systems there may be as many as hundreds of different available games.

When the player finally locates the game the player would like to play, there may be multiple variations of the specific game available for play. For example, for the game of poker there may be multiple games (Limit Hold'em, No-Limit Hold'em, Pot-Limit Hold'em, Omaha, 7-Card Stud, Razz), multiple game types (cash game, tournament, sit-and-go, freeroll), multiple game stakes (“$0.05/$0.10 Limit” through “No-Limit”), multiple game play styles (aggressive, tight) and multiple other game parameters such as game speed, disconnection protection, or skill based on the players on the table. Thus, for the game of poker, there may be thousands of available games and variations of games potentially capable of allocation to a player or selection by a player of the networked gaming system.

One problem with or issue presented by online gaming is the interaction of relatively high skill or proficiency players and relatively low skill or proficiency players. On the one hand, some high skill players are known to search out games with low skill players and take advantage of the low skill players, by wining the games and, of course, causing the low skill players to lose money, usually quickly. The low skill players can become discouraged and form a bias against continuing to play the games and use the gaming system altogether. Thus, this disparate skill level interaction can hinder retention of low skill players and their determination and/or ability to improve their skills. A high churn rate, or rate at which players join and the discontinue playing games is a complementary concept.

Another problem arising from the interactions of players of disparate skill levels is that many high skill players prefer to play games with person of the same skill level. This not only makes the game more interesting, but also more enjoyable. And the same is true for many low skill players, particularly novices. They would prefer to play with lesser skill players while they develop their own skills.

Simply designating games for a given skill level may be one solution (e.g. low/medium/high skill tables in poker games). It is not a foolproof one, particularly in on-line gaming. It is very easy for a player to adopt different on-line presences or personas so that a nefarious high skill player can adopt a high skill presence or persona for some gaming, and a low skill presence for seeking out low skill games where the high skill player can take advantage of low skill players. New and lesser skilled players often have no basis for assessing their relative skill level, and are often overly optimistic of their abilities, resulting in overly aggressive decisions with deleterious consequences to the bankroll and experience of the new or lesser skilled players. New players to a networked gaming system include users with limited experience in a new poker ecosystem and players acquired from a separate networked gaming system. The current system seeks to protect new and lesser skilled players by allocating specifically matched levels of games, including segregating new players within the networked gaming system.

U.S. Pat. No. 6,352,479 discloses a multiplayer online gaming system in which players are purportedly matched by skill level. The games involved generally are of the role playing type, e.g., combat games. The patent states that the game system server matches game players to appropriate games currently being played on the game servers based on the skill level required by the game and the corresponding skill levels of other current players of that game as represented by the game player statistics stored by the server and dynamically generates links for the game player to the appropriate games. The user can then select which game to play by choosing one of the dynamically generated links. Players are then presented based upon player preferences and where the players skill level exceeds the average of players currently playing the game. But there is no system for protection of new and lower skilled players from exposure to higher skilled players in the remaining games which may be available on the system. It would also appear that game allocation based upon beating the average would expose lesser skilled players already playing to highly skilled players. Accordingly there is no system for protection of new and lower skilled players from exposure to higher skilled players in the remaining games which may be available on the system.

Unites States Patent Application Publication 2004/009,287 discloses another multiplayer online gaming system. This publication states that it discloses a gaming systems where the gaming server computer generates a profile for each of the players, which may include the player's gaming proficiency, and socioeconomic and physical data of the player. The gaming server computer matches the players (as teammates or opponents) to play a game based on the profile of the players, supervises the game played by the matched players, modifies controllable parameters of the game being played, and manages a reward point account provided for each player. There is no system for attempted or enforced segregation of low and high skill players, and indeed, the reward system described encourages interaction between the two.

U.S. Pat. No. 6,648,760 discloses another gaming system in which player skill level is assessed. Discloses a gaming system in which player skill level is assessed. The assessed skill levels are used to classify players and to place them in appropriated categories in order to provide handicapping of the player. The handicapping is used in the traditional sense to overcome issues such as occasional deliberate low level play by high skill players. It does not teach player protection based upon a system for allocation of games.

Other issues can arise due to other differences between the players. This differences might be, e.g., differences in legal status, affiliation with the gaming system or channel from which the player was acquired.

### SUMMARY OF THE INVENTION

Disclosed herein are one or more inventions that can enhance a networked gaming system. Preferably, this is accomplished by protecting tables or games from certain players and thus protecting some players from other players.

In particularly preferred embodiments, these inventions provide one or more ways for enhancing the game experiences of both high skill and low skill players by segregating them and preventing or minimizing the ability of nefarious high skill players from taking advantage of low skill players. In the context of poker games, this would include either steering the players to appropriate tables or seating the players at appropriate tables.

Preferably such an enhancement will serve to retain low skill existing players as well as new players by grouping players by skill, whether via a soft mechanism of table ranking, or a hard mechanism of hiding low skill designated games/tables from the high skill players, hiding high skill games/tables from the low skill players, or both.

The present invention(s) operates(operate) with respect to games played by the game playing computers over the network, wherein games refer to any type of rule-based activity or contest between or amongst two or more players with goals and objectives attainable for the players. Games include but are not limited to knowledge based games (e.g. trivia games), creative games, individual or team sports games (baseball, football, soccer, hockey, golf, tennis, etc.), games of skill (poker, blackjack, bridge, etc.), role playing games, fantasy games, historical games, war games, problem-solving games, puzzle-solving games, contests, rehabilitation games, etc. Games may also include simulation events, such as the popular Flight Simulator program and the like. Herein, the invention is described mostly in terms of online poker games.

Thus, in one embodiment, disclosed herein is an online poker game system where low skill players are protected by directing them to tables that both meet the players' bankrolls and host similarly skilled players. This will balance players and protect low skill players from losing to high skill players and reduce the churn of novice players. This also allows the existing high skill or experienced players to play with players with similar skill levels.

The invention(s) preferably enhance and protect the experience of new, lesser skilled, and fully integrated players in a networked gaming system by integrating skill based and experience based protection schemes in order to improve or even out the competitive landscape for players. Introducing social functionalities tied to skill level into a wagering or skill game environment introduces a more casual environment, while the experience of players is further enhanced and protected by, e.g., bankroll management protections and game variant bonuses.

In an embodiment, disclosed herein is a networked gaming system in which access to a game is blocked or allocated to players based specifically on their skill level.

In another embodiment, disclosed herein is a method for determining a player's skill level.

In an embodiment, disclosed herein is a game system in which relatively low skill players and new players are directed to games that meet both their bankroll and host similarly low skilled players.

In an embodiment, disclosed herein is a system in which only games with players of a certain skill level are allocated and made visible to a player with a similar skill level.

In an embodiment, disclosed herein is a networked gaming system comprising a game server comprising one or more computers; at least one game hosted on the game server, wherein, the game server executes instructions that limit access to the game to those players who are valued at having a playing skill not exceeding a certain skill level.

In an embodiment, disclosed herein is a networked gaming system wherein a game client application connects a player to at least one game server having at least one game table. The game server provides game operations and displays for transmission to the game client application and a display including at least one screen display designating a lobby from which a player can request to be seated at one or more of a plurality of virtual game positions in one of a plurality of multi-player or single-player games. Additionally included is an overlay application, with the game server providing game operations and displays for transmission to said overlay application. The displays include at least one virtual lobby screen display accessible by the overlay application without a player having to login to the overlay application. Also, a player or operator may configure the networked gaming system so that when the play logs-in or clicks on a selection, the player is immediately taken to a game and “bought-in,” if necessary. The networked gaming system may further be configured with typical virtual lobby features allowing listing of all tables available to the player except the list is based upon protected table logic

These and other features and advantages are evident from the following description of the present invention, with reference to the accompanying drawings.

### BRIEF DESCRIPTION OF THE DRAWINGS

FIG. 1 is a graphical representation of one embodiment of a system in which the present invention may be practiced;

FIG. 2 is a screen shot of virtual lobby presented to a player in a known gaming system.

FIG. 3 is representation of a screen shot where a user selects a game to play in the known gaming system

FIG. 4 is a representation of a screen shot where a use joins a wait list in the known gaming system.

FIG. 5 is a flowchart of the approximate nineteen steps a user takes in order to play at a table in the known gaming system.

FIG. 6 is diagram illustrating a gaming system and its interaction with a player who logs on to the system.

FIG. 7 is a flow chart showing the handling of players who log on to the system and the players who are not logged on to the system.

FIG. 8 is a representation of selectable games presented in a lobby to a low skill player.

FIG. 9 is representation of selectable games presented in a lobby to a high skill player.

FIG. 10 is a flow chart showing the creation and serving up of a protected table.

FIG. 11 is a flow chart showing how players might be protected when using a player search feature.

FIG. 12 is a flow chart showing how players might be protected when using a quick seating feature.

FIG. 13 is a flow chart showing how players might be protected when using a quick seating feature as compared to a prior art quick seating feature.

FIG. 14 is a flow chart showing how players might be protected when using a buddy invitation feature.

FIG. 15 is a flow chart showing how players might be protected when using a global waitlist feature.

### DETAILED DESCRIPTION OF THE PRESENTLY PREFERRED EMBODIMENTS

The description that follows describes, illustrates, and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

A game server (sometimes host or share) is a server which is the authoritative source of events in a multiplayer game. The server transmits enough data about its internal state to allow its connected clients to maintain their own accurate version of the game world for display to players. The game server also receive and process each player's input. In most online gaming systems, the game server comprises one or more dedicated remote processing units configured to run logical code to serve up the games to the players, who interact with the game server via clients or terminals, usually in the form of personal computers, tablets, personal digital assistants and so-called “smart” cellular telephones. The game servers generally are in communication with data storage systems on which are stored data used in the served games, e.g., player histories, game data, etc.

In FIG. 1 there is illustrated a game server 10 representative of the one or more remote processing units and their associated memories or data storage units running logic that effect a game program. Clients 12a and 12b are representative of the communication units such as computers of the one or more players who interact with the game server to play the one or more games served up by the game server. Network 14 is representative of the various public or private networks, such as a local area networks or wide area networks the via which the clients 12a and 12b and the server computers 10 interconnect and communicate with each other. The connection can be via wires, ethernet being one of many such connections, or via wireless communications, cellular networks and Wi-Fi connections being just two of many such connections. The clients may run local logical code in the form of programs or applications in order to interact with the game server. One such reason is to provide secure connections.

The clients 12a and 12b may be any type of dedicated or general purpose computing device that is capable of allowing a user or player to interface and interoperate with gaming software executing locally (i.e. on the game playing computer 12a or 12b) or remotely (i.e. on another computing device interconnected over the network 14). Typical examples of the clients 12a and 12b, include a general purpose computer, a laptop computer, a mobile or hand-held computing device, a tablet computer or a gaming console, which may of the type known as Microsoft Corporation's XBOX, Sony Corporation's PLAYSTATION, PS2 of PS3, and/or NINTENDO Corporation's GAMECUBE, all of which are well known in the art. A television set configured with an appropriate set top box may be used as an interactive TV. In addition, wireless devices such as a personal digital assistant (PDA) and a cellular telephone may communicate via an antenna with a wireless or cellular network, which in turn communicates with the network 14 for communications with other game playing computers and/or the gaming server computer 10.

The gaming server 10 provides many functions and services to the clients 12a and 12b, which together form a gaming community. The gaming services to be described herein are shown as executing on a single platform, but of course may be distributed across multiple platforms as may be desired or required (e.g. for appropriate scalability, etc.). Distribution of services as described herein are well known in the art and need not be described in further detail.

For the purposes of much discussion herein, Client 12a has associated with it a player 16 who is deemed relatively inexperienced with respect to a representative game, while client 12b has associated it a player 18 who is deemed relatively experience with respect to the representative game. Herein a relatively inexperienced player is also deemed a low skill player and a relatively experienced player is also deemed a high skill player. Elsewhere, these different clients may be associated with players with other differences.

Bwin.party is a provider of various online games including poker games. Bwin.party provides poker games via the PARTYPOKER branded gaming system via the universal resource locator (URL) http://www.partypoker.com, as well as through other brands. There are other online poker game providers such as those mentioned in the background section of this specification.

U.S. Pat. No. 8,092,308, fully incorporated herein by reference, describes one iteration of the PARTYPOKER gaming system. This patent describes a networked gaming system wherein a player connects to at least one game server via a game client. The game server provides game operations and displays for transmission to the game client application and a display at least one screen display of a virtual lobby from which a player can request to be seated at one or more of a plurality of virtual game positions in one of a plurality of multi-player games, poker games in particular. In the PARTYPOKER game system, after logging on, a player or user is presented with a virtual lobby with various selections relating to among others, games, game types, stake levels and group sizes.

FIG. 2 (FIG. 13 of U.S. Pat. No. 8,092,308) is a screen shot of such a virtual lobby as might be presented to a player in the PARTYPOKER gaming system. According to U.S. Pat. No. 8,092,308, The virtual lobby may contain a top-level filter 111 that itself may contain broad categories such as: Cash Games, Jackpot Tables, Sit & Go, Tournaments, Tournament Events, or Play for Free. Second level navigation items 112 provide secondary navigation of specific games, e.g. the “Cash Games” top-level section may include Hold'em, Omaha, Stud and other games. A third level 113 filter may contain other refiners such as stakes, e.g. All, $5/10, $ 10/20, etc.

U.S. Pat. No. 8,092,308 states that when changing the filters, the selection change is requested immediately so that a submit command (e.g. clicking on submit button or hitting return) is not required. Order of filtering is from first to third level descending, i.e. the top-level selection influences the second level, which influences the third level, which influences any other levels there may be. If the user changes the top-level navigation 111, both second level navigation items 112 and third level 113 will change. Initial selection in the Poker lobby may be: Cash Games>Limit Hold'em>$100/$200.

For live games (not tournaments), the fields “Table” 115, “Stks” (Stakes) 116, “Plrs/Sts” (Players/Seat) 117, “Wtg” (Waiting) 118, “H/hr” (Hand/hour) 119 and “AvgPot” (Average Pot) [not shown] may be displayed in the table list. Full tables may be displayed in a different color or not shown. There may be a full table filter 120: a button will let the user hide or show full tables. By default the button may be pressed and say “Show full tables.” In this case, full tables are being hidden. If the user depresses the button, it will say “Hide full tables.” Full tables would then be shown. Per U.S. Pat. No. 8,092,308, in general, all of the same filters as available in the main client should also be possible in the messenger.

If there are no results available in the table list, the table list will be empty, just showing one entry messaging “No tables available. Use the filters to find other games or check back at a later point.” If tables exist, but are not being shown due to an active full table filter, the full table filter button 120 deactivates and the tables will be shown, even if full. The button setting is remembered and as soon as the user changes the selection, the button jumps back to its settings. All fields/columns can sort the table list the same way as currently a poker client lobby does. Sorting is in an ascending/descending fashion, following the same behavior a poker client virtual lobby has.

FIG. 3 replicates FIG. 14 of U.S. Pat. No. 8,092,308. Per the patent, by left-clicking 122 on a table 121, the table will be highlighted. Double-clicking on a table, it will open. You can also open through the “open” button 123 below the table list, as seen in FIG. 2 (FIG. 13). An “Open” button 123 lets users enter a game after highlighting it. If a user highlighted a table, which he is already sitting at, the “Open” button 123 will de-activate. The “Waitlist” button 124 lets the user join a waitlist for a table. As in the some poker lobbies, the Waitlist button 124 will show the number of people waiting already. In this example, that number is zero (“0”).

FIG. 4 replicates FIG. 15 of the patent. Referring to FIG. 4, U.S. Pat. No. 8,092,308 states that right mouse-clicking 130 on a table will bring up a context menu 131 where the user can may see an open button 123, a join/unjoin a waitlist button 124, and may see information 134 about players at the table.

The rules defined for the Open button 123 and Waitlist button 124 apply to the buttons in the menu as well. Clicking on the “Open” button 123 the user will enter the table. In case he is already on the table (means, the table is open), playing or not, the table will become active, i.e. jumping in the front of the monitor. Clicking on the “Waitlist” button 124 the user will enter the table's waitlist. In case he is already on the waitlist, the button will be inactive and a small icon will be messaging the fact and he will have the option to unjoin. Referring to FIG. 13, the Auto-Seat button 135 will save the user from manual selecting and immediately sit him on a free table. The Auto-Seat feature will follow the selection process of the Waitlist option.

Navigation, selection, and access to the table happens in the messaging application lobby. From there the table picks up the process. This implies the fact that a poker table does not need a poker client open to play. After the user double-clicks or opens a table, the table opens up so the user can watch the table. If the user wants to take a seat, buy-in, and any other features are being taken over by the existing table functionality. As is the present case, at this point the blocked country list is enforced.

U.S. Pat. No. 8,092,308 also describes an automated seating function. This function is referred to herein as the AutoSeat and/or QuickSeat function.

The AutoSeat function automatically selects a game table for the user, opens it up, buys-in, and sits the player down. The logic of table selection in the AutoSeat feature may be taken and modified from the existing Waitlist functionality. FIG. 5, which replicates FIG. 7 of U.S. Pat. No. 8,092,308, is a flowchart that shows an embodiment of the about nineteen steps it takes a user to sit at a game table to play. First, the user begins in a lobby 50. From there, the user selects the game group 52. The game group query is narrowed by various filters 53. Alternatively, if the user would like to play at a table with a “buddy” from a buddy list, the user may search for buddy 51. The next step is to enter the table 54. Then the user sits the player down 55 at the table. Finally, a user may begin playing 56. The approximately nineteen steps may include: 1. Select game group (e.g. Cash games), 2. Select game type (e.g. Limit Holdem), 3. Select stakes (e.g. $5/10), 4. Select filter to limit choice of tables, 5. Sort table list by specific column, 6. Scroll table list, 7. Find free table, 8. Highlight table, 9. Select table, 10. Open table, 11. Check of logged-in, 12. Check if seat free, 13. Check if enough money/points for buy-in, 14. Time-out for sitting down, 15. Check blinds (defined below) at table, 16. Geographic preference to sit, 17. How much money to take to table, 18. One or more players at table, and 19. Wait for blinds. In contrast to the nineteen step process described herein and depicted in FIG. 7, the AutoSeat feature allows for seating at a table using only one step: signing on and clicking on the sit down button.

As stated in U.S. Pat. No. 8,092,308, an overlay application may include a selectable automated seating option (or AutoSeat) for automatically seating a player at one or more of a plurality of virtual game positions, wherein a player is directly seated when the player logs-in to the networked gaming system. A networked gaming system may include an automated seating option (or “AutoSeat” feature”) of said mobile game client application capable of receiving and storing personal preference information, including but not limited to a game category, a specific game type, stakes, and an amount of money to be taken from a player's account when seating a player, and for seating a player at a table in accordance with said stored personal preference information. AutoSeat favorites are those of the type where the user has selected the AutoSeat option and provided more information and is then automatically seated and “bought-in” when the user chooses this option. For example, if a user has the AutoSeat option selected on a No-Limit Hold'em table, having blinds of $1/$2, and a user buy-in of $200, then once the user signs on he will automatically be taken to a No-Limit Hold'em table, having blinds of $1/$2 and the user will be bought-in for $200 automatically. The goal of the AutoSeat functionality is to get users seated more quickly on a table.

The automated seating option of the game client application may be further selectable by the networked gaming system, whereby personal gaming history, including but not limited to a game category, a specific game type, stakes, or an amount of money that a player commonly plays, may be recorded by the networked gaming system and a player may be taken directly to a table, upon logging into the system, in accordance with the recorded personal gaming history of a player. Further, based on the personal gaming history of a player, some amount of money may be taken from a player's account when seating a player, such that the player is seated with said amount of money usable for game play. Also, the automated seating option may be manually selected by the user. Currently, there are approximately nineteen steps required to open the gaming application and sit at the table with cash. The AutoSeat feature allows for seating at a table using only one step: signing on

Also, a game client application may include a selectable automated seating option with the same operations as the automated seating option described above that is incorporated into an overlay application.

The main motivators for the AutoSeat feature are (1) to assist users in getting a table of their choice in a large, dynamic, and quickly moving data set of tables or games, (2) make the seating process more convenient for user, (3) use history and stored information to overcome ambiguous situations on the way to getting seated, and (4) apply the service to a number of frontends/interfaces from which the user might be accessing the networked gaming system.

The AutoSeat feature may be either backend- or frontend-driven.

Currently to sit a player at a table (game), the PARTYPOKER system looks at, among other things, at what type of table the player wants to sit, taking into consideration, among other things, the game selected, the game type selected, stake level selected and size of group preferred. Also, the AutoSeat/QuickSet function has the process identified in FIG. 5. As mentioned above, there are many different ways to determine where to seat a player.

Disclosed, herein, however, is a system that regardless of whatever other algorithms and criteria are used for seating a player (i.e., placing a player in a game or even allowing a player to play a game), the system preferably uses a skill level assessment and/or bankroll management rules to determine either or both whether the player is allowed to see or be aware of certain tables (games) or join certain tables (games).

In FIG. 6 there is illustrated a gaming system including a game server, a player database and a data warehouse. Each of these preferably comprises one or more server units with suitable processors and storage or memory. The game server serves up the games to the player and otherwise establishes the gaming environment. The game server also tracks data relating to each player's gaming and send game history, sends gaming history to the data warehouse where cumulative gaming history can be stored and reviewed.

As discussed in greater detail below, the data warehouse is used to calculate a skill level value for each player, and then translate that value into either a “protected” and “unprotected” category or classification. The data warehouse then feeds that classification to the player database, along with any other desirable information.

In a preferred embodiment, the categories are only “protected” and “unprotected.” As also explained in greater detail below, this determination involves evaluating a skill value calculated for each player. It can be appreciated that the skill levels can be divided into any number of categories depending on the degree to which one wants to more finely consider the skill levels. However, in the present discussion, the calculated skill levels are translated into only the two protection levels. Thus, relatively low skill players are designated as “protected” players and relatively high skill players are designated “unprotected” players. Additionally, the protected and unprotected players may be referred to herein also a low skill players and high skill players, respectively. The low and high terminology is only meant to indicate a relative difference, not any specific degree of or only the extremes of the difference between skill levels.

As illustrated, upon login of a user, the game server retrieves player information from the player database. This information can include a myriad of information such as gaming history. Of particular importance, the game server retrieves the protection category designation for the player from the database player database.

Additionally, as used herein, a “protected table” is a table or game to which access is limited based upon criteria discussed herein. For example, a protected table can be one to which only protected players have access or even awareness. Of course, other configurations can be considered.

On the other hand, “regular” or “unprotected tables” are tables or games the access to which and/or awareness is not limited. That is to say the same criteria would not apply. For example, an unprotected table could be limited to only unprotected players, or open to any type of player. Again, other configurations can be considered.

As illustrated, upon log in of a player a suitable client computer, the game server retrieves the players protection designation. Preferably this is done independently of any other algorithm or other determination regarding player preferences, etc. Once the protection designation information is retrieved, that information is used to determine the tables to which the player can be allocated, i.e., the tables the player can access, or even about which information will be provided to the player. As discussed above, the purpose is to “protect” the low skill players from the issues arising in connection with interactions between low skill players and high skill players.

Again referring to FIG. 6, if a player is determined to be a protected player, then the player can either be presented that player's virtual lobby with, e.g., (1) the ability to join protected and unprotected tables, (2) presented with the ability to join protected and unprotected tables, but with the tables presented or sorted in such a way to encourage play at the protected tables, or (c) or only protected tables. In FIG. 4, protected and unprotected tables are made available to the protected player.

As also illustrated, preferably, only unprotected tables are presented or made available to the high skill player or unprotected player in that player's virtual lobby. That is to say, the unprotected player will not be able to join a protected table either because the table is not listed (i.e., it is hidden) or simply not selectable, (i.e., the system will not let the player join the table) despite attempts to select it.

FIG. 7 illustrates in flow chart form how both logged in and non-logged in players are handled. After launching a local client or a virtual client, a player is then presented with a lobby or portal via which the player may via information about tables that are available to join, and otherwise login. The way logged in players are handled was generally discussed above. Non-logged in players are treated as specially protected players and are given information only about “protected” tables.

In a “soft mechanism,” players with lower skill preferably are shown tables (games) visually tagged or identified internally in the system as “protected” and placed higher in a ranked list of available games in the virtual lobby. These protected tables (games) would also be selected first by the AutoSeat or QuickSeat mechanism of the software. In this way, players with the same skill or similar skill can be pooled together. Preferably, at the same time, more skilled players are able to see and access all tables, however these are mixed into the overall table mix without any further tagging.

In FIG. 8, there is illustrated a representative portion of a virtual lobby for a protected player. As illustrated, the protected tables (games) 30 are placed at the top of the ranked list. The asterisk is used solely to identify for the reader the protected games, and there would be no such visual identification to the player. The unprotected tables 32 are placed lower on the list.

In this example, the player has selected to view $10/$20 NLH tables and has sorted by Blinds

The protected players sorted view thus is—Blinds->Protected Tables->Operator Specific->Plrs/St

As it happens, lower skill players tend to pick from among the top tables (games) presented, so those tables (games) presented higher in the lobby list are much more likely to be selected. Yet, the low skill player is not prevented from scrolling down a list and choosing an unprotected table (game).

As a variation, it could be that there can be a specific visual identification more prominent to the low skill player as to whether listed tables are “protected.” This would enable a more conscious decision of a low skill player to join a table (game) geared toward a given skill level.

Referring to FIG. 9, there is illustrated a representative portion of a virtual lobby for a high skill player under the “soft mechanism” protection scheme. As illustrated, when a high skill player logs on to the system, the sorting of the tables (games) presented would be unchanged due to the level of skill identified for the tables. Here, the protected tables 30 and unprotected tables 32 are scattered in the listing where the tables (games) are ranked according to some other criteria. Again, the asterisks in the list are only for the benefit of the reader, and preferably there is no visual identification of the protected nature of the tables to the high skill player.

This player is also looking at $10/$20 NLH tables and has sorted by Blinds.

The unprotected players sorted view is: —Blinds->Operator Specific->Plrs/Sts

If both types of players sort by Name, their views would be sorted as follows:
Protected Players View—Name->Protected Tables->Operator Specific->Blinds->Plrs/Sts
Unprotected Players View—Name->Operator Specific->Blinds->Plrs/Sts

If both players sort by Average Pot, their views would be sorted as follows:
Protected Players View—Avg Pot->Protected Tables->Operator Specific->Plrs/Sts->Blinds
Unprotected Players View—Avg Pot->Operator Specific->Plrs/Sts->Blinds

If both players sort by Players per Flop, their view would be sorted as follows:
Protected Players View—Plrs/Flop->Protected Tables->Operator Specific->Plrs/Sts->Blinds
Unprotected Players View—Plrs/Flop->Operator Specific->Plrs/Sts->Blinds

To summarize, the sort order for a protected player is shown in Table 1:

Protected Player's View

TABLE 1

| Column | | | | | |
|---|---|---|---|---|---|
| Name | Primary | Secondary | Tertiary | Quaternary | Quinary |
| Name | Name | Protected | Operator | Blinds | Plrs/Sts |
| | | Tables | Specific | | |
| Blinds | Blinds | Protected | Operator | Plrs/Sts | n/a |
| | | Tables | Specific | | |
| Plrs/Sts | Plrs/Sts | Protected | Operator | Blinds | n/a |
| | | Tables | Specific | | |
| Wait | Wait | Protected | Operator | Blinds | Plrs/Sts |
| | | Tables | Specific | | |
| H/hr | H/hr | Protected | Operator | n/a | n/a |
| | | Tables | Specific | | |
| Avg Pot | Avg Pot | Protected | Operator | Blinds | Plrs/Sts |
| | | Tables | Specific | | |
| Plrs/Flop | Plrs/Flop | Protected | Operator | Blinds | Plrs/Sts |
| | | Tables | Specific | | |

The sort order for an unprotected player is shown in Table 2:

Unprotected Player's View

TABLE 2

| Column | | | | | |
|---|---|---|---|---|---|
| Name | Primary | Secondary | Tertiary | Quaternary | Quinary |
| Name | Name | Operator Specific | Blinds | Plrs/Sts | n/a |
| Blinds | Blinds | Operator Specific | Plrs/Sts | n/a | n/a |
| Plrs/Sts | Plrs/Sts | Operator Specific | Blinds | n/a | n/a |
| Wait | Wait | Operator Specific | Blinds | Plrs/Sts | n/a |
| H/hr | H/hr | Operator Specific | n/a | n/a | n/a |
| Avg Pot | Avg Pot | Operator Specific | Blinds | Plrs/Sts | n/a |
| Plrs/Flop | Plrs/Flop | Operator Specific | Blinds | Plrs/Sts | n/a |

In a “hard mechanism,” system of protection, preferably the system will only host low skill players at protected tables. At the same time, protected tables are never listed in the virtual lobby of the high skill players.

In a variation, however, the “hard mechanism” system is altered so that low skill players can be made aware of the availability of unprotected tables, and be permitted to join them. This can be done with or without a visual identification of the protected and unprotected tables in the virtual lobby of the low skill player.

In a another embodiment, protected tables are also characterized as (a) having stakes lower than a predetermined limit, (b) being visible only to low skill players, and (c) listed at the top of a list of tables available to the low skill players.

FIG. 10 illustrates generally how protected tables are served up. In a backend, the series of management functions occur whereby a table is set up to be a “protected” table. This can occur manually, i.e., a series of humans make a determination to set up a “protected” table, or the system can determine on its own, via suitable programming to do so. The actual manner is which the determination is made is not critical. Once a virtual tale is determined to be a “protected” table, it is indicated as such in the database server. When searching for available tables, the game server then can locate the table and recognize it as a “protected” table. The game server then will list the table as an available table for protected players in accordance with the rules discussed above.

The PARTYPOKER system described in U.S. Pat. No. 8,092,308 also has other features that can be affected by the protection systems employed to protect low skill players. These features include a “Player Search” feature via which a player can search for another player who might be logged on to the system; the “QuickSeat” or “AutoSeat” function described above via which a player is caused to by-pass the virtual lobby and immediately seated at a table (game) upon logging in, based on preset preferences; a “Buddy Invitation” feature via which the system will seat the player with another player indicated as a friend or buddy; and a “WaitList” feature

Preferably, in the “Player Search” feature, for the “hard mechanism” the following rules apply:

1. Protected players can search for any player sitting on any table.

2. Un-protected players can search for any un-protected player sitting on un-protected tables.

3. Un-protected player can only search for protected players sitting on un-protected tables.

As a result, high skill/unprotected players cannot see the protected tables joined by protected players; but can see the unprotected tables.

In FIG. 11, there is a flow chart illustrating this logic.

Preferably, in the “QuickSeat” feature, the following rules apply:

1. When a protected player allows the system to seat him automatically, he will be seated at protected tables only. If there are no suitable protected tables, the player will be seated on the next best un-protected table, using the QuickSeat rules described above.

2. When an un-protected player uses the QuickS eat function, he will be seated on the most suitable un-protected tables using the QuickSeat rules described above.

In FIG. 12, there is a flow chart illustrating the implementation of this logic.

In FIG. 13, the is a flow chart that essentially is a modified version of the flow chart of FIG. 5 to show how the QuickSeat feature is modifies to accommodate table allocation for protected players.

Preferably, in the “Buddy” feature described above, the following rules set forth in Table 3 apply:

TABLE 3

| | | | Allow Invite |
|---|---|---|---|
| Sender | Receiver | Table Type | Yes/No? |
| Low Skill | High | Protected | NO |
| Player | Skill | | |
| | Player | | |
| Low Skill | High | Un-protected | Yes |
| Player | Skill | | |
| | Player | | |
| Low Skill | Low | Protected | Yes |
| Player | Skill | | |
| | Player | | |
| Low Skill | Low | Un-protected | Yes |
| Player | Skill | | |
| | Player | | |
| High Skill | Low | Protected | n/a (high skill |
| Player | Skill | | player not |
| | Player | | allowed on |
| | | | protected table) |
| High Skill | Low | Un-protected | Yes/No |
| Player | Skill | | (configurable) |
| | Player | | |
| High Skill | High | Protected | n/a (high skill |
| Player | Skill | | player not |
| | Player | | allowed on |
| | | | protected table) |
| High Skill | High | Un-protected | Yes |
| Player | Skill | | |
| | Player | | |

What the rules in Table 3 set forth is whether the system will permit a sender's invite to proceed taking into consideration the skill levels of the sender and the recipient, as well as the protected/unprotected status of the table (game) involved. The rules should be easily understood from the table, however, as an example, example 5 in the table, given a high skill sender, a low skill recipient and a protected table, the invitation will not be allowed to proceed. In other instances, the invitation will be allowed to be sent.

Thus, for whatever program instructions are executed to perform a “Buddy” invitation system, the tables are protected by additionally including an additional instruction, separately from or integrally with the program instructions, that follows the logic in Table 1, to deny or allow an invitation to be sent out via the system.

In FIG. 14 there is a flow chart illustrating the implementation of this logic.

In another preferred embodiment, players may be protected by the system which recommends a “Buddy” to a player via a Friend recommender system “eg Poker Friends” whereby players who met the same criteria to be seated at a protected table together, and are among the players who could be affirmatively invited by a player, can be randomly selected and identified by the system to the player via a traditional instant messaging feature, pop up text, chat message, email, text or other means of communication. Acceptance of a recommended Poker Friend would trigger an invitation utilizing the “Buddy” invitations system described above. Factors other than skill level would typically also drive recommendation of a Poker Friend by the system, such as geography, language, age, mutual friends, game type preference, time of day playing or other player profile data. Players are thus recommended Poker Friends consistent with the parameters for player protection, and a players' experience in the gaming ecosystem is further enhanced by facilitating social and casual elements of game play.

Regarding the “Wait List” feature, when offering a player a seat from a global waitlist, the following rules preferably apply:

1. A low skill player is offered a seat at a protected table (game).

2. If no protected tables are available, the low skill player is offered a seat at an unprotected table according to other criteria selected by the player.

3. A high skill player will be offered a seat at an un-protected table (game).

4. High skill players are never offered a seat at a protected table.

FIG. 15 is a flow chart illustrating the implementation of this logic.

The above rules can apply for the whole poker pool or just specific game groups like cash games, sit and go, fast poker, or specific tournaments. This allows to support not only promotional, but also regulatory goals, where regulators may require an operator to pool specific game types while allowing to mix players in other game types

In another preferred embodiment, the above rules can be opted in or opted out by a player eligible for protection as part of a player preference in the player's profile, allowing a player who would be a protected player based upon skill level or other criteria to have games allocated to him or her in the same manner as an unprotected higher skilled player. In this alternative, the player could opt out and later opt back in to be protected, provided the skill level value or other criteria for protection still applied.

In another preferred embodiment, the virtual lobby for game selection could be sectioned to have protected games or tables based upon skill level and other available game selections without any segregation of players based upon skill. In this way, protected tables could be offered by the operator as a game type.

In another preferred embodiment, further segregation schemes can be employed in addition to or instead of the just described low skill player versus high skill player segregation scheme. These schemes/logic include having multiple levels of protection in which players with skill level of a certain range are allocated games which are neither above or beneath a certain range. For example, instead of low skill players protected from high skilled players, a third category of players between low and high skill could be part of a protection scheme. Low skilled players could be protected, still from all players above their skill level range, and medium skilled players could be protected from the high skill players above them. A fourth or fifth etc. layer of player skill range could be added to the networked gaming system in this manner.

In another preferred embodiment, in order to change the gaming ecosystem to improve or decrease liquidity (liquidity increases as lower skilled players meet and play higher skilled players), adjustments may be made to the system and level of protection by varying the range of skill considered by the system to identify a protected player.

The skill level associated with each player can be assessed in various ways, including depending upon a particular game server operator's experiences. As mentioned above, various prior art patent patents describe ways in which skill level is assessed based on certain prior gaming experiences on the system.

In a preferred embodiment, a way to assign a skill level value (“SL”) is to use the following general calculation:

SL=SUM(Take*(Win_amt−Bet_Amt))/SUM(rake)

Preferably, the calculation is performed only from a minimum number of game plays (hands in poker), which is a sufficient number of game plays for the game in order to be able to determine skill level with confidence. For poker that minimum preferably is 100 hands. “SUM” indicates a summation for 1 to n plays, n being a minimum number of plays for which the calculation will be run. For example, if player has played less than 100 game plays or hands, SL is set equal to −1, the extreme of a protected status calculation. If a player has played 100 or more hands or game plays, the indicated factors will be calculated for each hand or game play, and the summation of the results for each factor will be used to SL. The number of preferred game plays for protected status may be modified to fit the style of play, duration or type of game.

SL is a capped valued for some players, as mentioned above, and SL can range between end points for extreme skill differences between other players for example between −11 and +9, inclusive.

In the calculation:

1. “Rake” is the amount of money the house keeps from the pot before winnings are distributed to the winning player or players (“win_amt”) in the hand played by the player whose SL is being calculated. Rake depends on pot size and limitations (number of active players, Flop, Stakes etc.)

2. “Win_amt” is the amount of money the player whose SL is being calculated received from the pot in one hand

3. “Bet_amt” is the amount of money the player whose SL is being calculated puts into the pot in one hand and minimum another player puts into the pot

4. “Take” is a coefficient calculated for each type of game or product offered by the gaming service that has been active for a minimum amount of time, preferably at least one month. Otherwise “Take” defined as the Take for a similar game or product offered by the gaming service. Take preferably is calculated as Take=sum(rake)/ABS(sum(loser losses)). The value Take is between 0 and 1, inclusive.

5. “Loser_Losses” is calculated as Loser_Losses=SUM(Win_amt−Bet_Amt) for all players for given period with negative SUM(Win_amt−Bet_Amt)

6. “Product” is defined as a table or game (tournament) with a unique configuration of Game, Limit, Seats, Stakes, Currency, Speed, etc. (for example: Cash Games, Texas NL, Max 6, $2/$4, Normal Speed)

Preferably the data warehouse device performs the calculation daily but can also be configured to calculate every six hours, or any other time interval or upon completion of one or more games or hands. Recall that new players preferably are assigned an SL value of −1.0 until they have played a minimum number of games or hands or are otherwise shown to be of a higher skill level.

In another preferred embodiment, the data warehouse device calculates the SL value for each player continuously during a gaming session with the results of each game play (or hand in poker).

In another embodiment, the data warehouse device continues to calculate skill of players from a range such a −10 to +10, and many of tenths of intervals in between assigning values that are both well above and well beneath the SL value of −1 to +1 which may be assigned to a new player. The system is capable of setting a range for protected players which may utilize a bottom value for protection which is higher than the lowest measurable skill level. In this configuration, protected players may not include all players with poor skill values, in order to except players not apparently susceptible to churn.

In addition to the foregoing, the low skill players can be protected in other ways. In one way, in a poker game environment, a bankroll management rule set can be implemented. Preferably, a bankroll management system would follow the following logic:

1. A low skill player would be limited to 20 buy-ins for No Limit and Pot Limit Games. Setting a buy-in to 100 Big Blinds, a player would need 2000 times the Big Blind of a table to sit at the table. Blinds are forced bets posted by players to the left of the dealer button in flop-style poker games. The number of blinds is usually two, but it can range from none to all players seated at the table. Generally, a “big blind” is equal to the minimum bet. The blinds exist because Omaha and Texas Hold'em are frequently played without antes, allowing a player to fold his hand without placing a bet. The blind bets introduce a regular cost to take part in the game, thus inducing a player to enter pots in an attempt to compensate for that expense.

2. A low skilled player would be limited to 150 Big Bets, with a relatively Big Bet being double the amount of a Big Blind at a limit table. Thus a player must have a bankroll that is at least 150 times the Big Bet to sit at the table.

In a fixed-limit poker game, a Big Bet is the larger of two fixed bet amounts. A Big Bet is used in the final rounds of a game to increase the pot amount and thereby enable the possibility of a bluff. Big Bets are generally double the wager of the initial or small bet. Any multi-round poker game can use Big Bets to standardize wagers while maintaining a sufficient risk-ratio to encourage bluffing. Casino poker tables use Big Bets to set a limit to the amount of money a patron can lose in each wager.

While any multi-round poker game can use Big Bets, the unlimited buy-in nature of casino style play is best suited for Big Bet limits.

Texas Hold'em

In a $2/$4 Texas Hold'em game, the Big Bet would be $4, wagered in each bet of the last two cards. The $2 would be the small bet, wagered during all other bets of the game. Given that a small bet is generally half of a Big Bet and that a small blind is generally half of the small bet, the minimum Big Bet in casino style Hold'em is two cents.

3. A low skill player must have a certain multiple, preferably 30, of the buy-in for a Sit and Go to play. This includes the juice.

A Sit and Go is an online poker tournament. Each Sit and Go has a predetermined number of players so once the spots are filled, the game starts. Juice refers to any money collected by the house, which, in the context of this application, is the game system. For these calculations, it is preferable to combine not only the actual amount of real money the player has on account, but also any credits awarded by the system when determining the player's bankroll.

Examples of bankrolls needed to play No Limit and Pot Limit games in accordance with these rules are shown in Table 3:

TABLE 4

| Stake | Bankroll |
|---|---|
| $0.01/$0.02 | $0-$40 |
| $0.02/$0.04 | $40.01-$80 |
| $0.05/$0.10 | $80.01-$200 |
| $0.10/$0.20 | $200.01-$400 |
| $0.25/$0.50 | $400.01-$1,000 |
| $0.50/$1 | $1,000.01-$2,000 |
| $1/$2 | $2,000.01-$4,000 |
| $2/$4 | $4,000.01-$18,000 |
| $3/$6 | $8,000.01-$12,000 |
| $5/$10 | $12,000.01+ |

With respect to the Quick Seat function, the following rules can be implemented:

A player's Quick Seat default stake level is set based on the Bankroll Management rules discussed above. For players that store the last used stake level, this will only be set for the first login. For all other logins, the last used stake is the new stake.

For players that do not store the last used stake level the Bankroll Management rules will be used every time.

Thus, if a player tries to take a seat at a cash game, if the player is a protected player, the player will be seated at a protected table or, if so configured, on an unprotected table if no protected tables are available. If the player is an unprotected player, they will be seated at a regular or unprotected table.

For the virtual lobby, the following filtering rules can be applied for new or protected players:

If the new player does not deposit money, or If the player selects Cash Games they should be taken to a welcome lobby using the following filtering

Game Name
Welcome Lounge Tables
GameType
Any
Seats
Any
Wait
Any

Once the new player clicks on any other section of the lobby the subsequent default filtering should be used

Fixed Limit Hold'em
Stakes/Blinds
ALL
Table Types
Regular
Gameplay
Regular
No Limit Hold'em
Stakes/Blinds
ALL
Table Types
Regular
Seats
6
Pot-Limit Hold'em
Stakes/Blinds
ALL
Table Types
All
Gameplay
Any
Fixed Limit Double Hold'em
Stakes/Blinds
ALL
Table Types
All
Gameplay
Any
No Limit Double Hold'em
Stakes/Blinds
ALL
Table Types
All
Gameplay
Any
Fixed Limit Omaha
Stakes/Blinds
ALL
Table Types
All
Gameplay
Any
Pot-Limit Omaha
Stakes/Blinds
ALL
Seats
Any
Gameplay
ny
Fixed Limit 7 Card Stud
Stakes/Blinds
ALL
Seats
Any
Gameplay
Any

When the new player clicks on Sit & Go's the below filtering should be used

Sit & Go's
Game Name
1-Table
Buy-in
ALL
Gameplay
Standard
Status
Registering

When the new player clicks on Tournaments the below filtering should be used

Tournaments
Game Name
Regular
Format
Regular
Game
Hold'em
Starting
Any

It can be appreciated that given the foregoing, low skill players can be “protected” in a variety of ways from the high skill players by varying degrees of segregation or allocation.

In addition, non-proficiency based factors including but not limited to bankroll, recent wins and losses variances, geography, player preferences, playing style (e.g. number of “all-in” bets, number of “flops” seen), reaction times (e.g. time to fold, call, raise, time outs) may be added to the criteria and algorithm used by the system to allocate games. The criteria may each be weighted and numerically scored (e.g. numerical value for geographic proximity based on distance, number of flops compared to average of players of corresponding skill). Several examples are described next.

Player acquisition channel: depending from which acquisition channel a player is coming, an acquisition channel can be associated with the player via any suitable association. A player associated with a given acquisition channel or any of a group of acquisition channels can be segregated to segregated tables. Preferably this segregation would follow the segregation schemes discussed above, merely using a different value. This could be done to create acquisition channel-specific game pools for a group of affiliates, a specific advertising campaign, a specific bonus or else. Focus may be protection but also promotional purposes.

Player value: segregation based on player value (=value represented for each player for the poker room). Value can be described in different ways, whether by gross gaming revenue (=rake), or by net value (=rake−bonus−affiliate acquisition cost) or other.

VPIP (voluntary put into pot): this measures how often a player voluntarily invests money into a hand. Paying the big blind, the small blind, or the ante is not considered voluntary. Therefore this percentage indicates how often you either called, bet, or raised. The lower this value, the tighter the player, the higher, this value, the looser the player. This value may be further adjusted by how many opponents are in the game with player. The VPiP statistic shows how often a player adds money to the pot preflop. A value of 100 would mean that a player plays every hand and a value of 0 means that a player does not play any hands. So the VPiP statistic determines if a player is loose or tight.

The VPiP formula is: Voluntarily put $ in pot %=(times voluntarily put $ in pot)*100/(Hands played)

Player Conduct: player activity levels like measurable player aggressiveness, multi-tabling, fair or unfair behavior (e.g. rat-holing, collusion, . . . ) may be measured and assigned a mathematical value in a range, and utilized as an allocation factor to further protect player experience.

Player geography/country: Players can be grouped by country, state or city if desired. Again, all that is needed is for one of these factors to be associated with a players profile and the player would then be directed to segregated tables appropriate.

The system is not limited to gambling or wagering applications. Player experience, satisfaction and churn are also important factors in acquisition of players and player retention in both play-money-play games and social games. Monetization in a social gaming or non-wagering environment is tied to user purchase opportunities such as purchasing additional virtual currency, avatar enhancement, game functionality enhancement, game time and level extension, etc. The financial success and player enrollment and retention of such applications are driven by many factors most of which translate back to the enjoyability of the experience of playing the game. The current invention is able to protect player experience in a networked social or non-wagering game in the same manner as a wagering game, by allocating specific games to the new or lesser skilled player in order to prolong the time of play and opportunity for success and skill improvement.

Although modifications and changes may be suggested by those skilled in the art, it is the intention of the inventors to embody within the patent warranted hereon all changes and modifications as reasonably and properly come within the scope of their contribution to the art.

What is claimed is:

1. A method for controlling access to a plurality of games in a skill-based electronic game network comprising:
determining a game skill level value for a player in the skill-based electronic game network in accordance with predetermined criteria that includes game playing history of the player,
within the electronic game network, classifying the player into at least one of a plurality of predetermined player protection categories and associating a player protection classification value with the player;
within the electronic game network, designating an access protection category for at least one of the plurality of games and associating an access protection classification value with the game; and
providing or denying electronic access to the at least one game to the player based upon a comparison of the player protection classification value of the player and the access protection classification value of the at least one game.

2. The method of claim 1, further comprising presenting the player, via the electronic game network, with a listing of available games to which the player will be given access based on respective access protection classification values associated with the listed games.

3. The method of claim 2, wherein the listed games are sorted on the listing based on the game access protection classification values.

4. The method of claim 2, wherein the listing excludes the at least one game.

5. The method of claim 1, wherein the at least one player is allowed to access the at least one game if a second player with a player protection classification value different from that of the at least one player is a participant in the at least one game.

6. The method of claim 1, wherein the at last one player is not allowed to access the at least one game if a second player with a player protection classification value different than that of the at least one player is a participant in the at least one game.

7. The method of claim 1, wherein the player protection categories include relatively low skill player and relatively high skill player categorizations, and the access protection classification value is one of a relatively low skilled player game category and a relatively high skill player game category.

8. The method of claim 1, wherein the game is an electronic networked poker game.

9. The method of claim 1, wherein the electronic access is provided or denied based on an amount of an electronic bankroll of the player.

10. The method of claim 1, wherein access to the at least one game is further provided based on an electronic invitation associated with a second player having a game skill level value within a predetermined range from that of the of the at least one player.

11. The method of claim 1, wherein access to the at least one game is further provided based on an electronic invitation associated with a second player having profile data in common with that of the ate least one player, the profile data selected from the group consisting of a language, geography, age, mutual friend, game type preferences, and time of day playing.

12. The method of claim 1, wherein access to the at least one game is further provided based on a determination of at least one non-proficiency based factor selected from the group consisting of a playing style, reaction time, and player value.

13. The method of claim 1, wherein access to the at least one game is based upon the range of values associated with the player protection category meets one or more of:
(a) the range of values associated within the game access protection category, and
(b) ranges within a plurality of game access protection categories.

14. The method of claim 1, further comprising allowing access to the game if an indication to not deny access to the game been received from the player.

15. A system for controlling access to a plurality of games in a skill-based electronic game network comprising:
an electronic data warehouse server configured to determine a game skill level value of a player in the skill-based electronic game network in accordance with predetermined criteria including game play history, and to (a) store a player protection classification value for the at least one player, and (b) store an access protection classification value for at least one of the plurality of games, the game access protection classification value for the at least one game; and
an electronic game server configured to allow or deny the player electronic access to the at least one game based upon a comparison of that player's player protection classification value and the game access protection classification value of the at least one game.

16. The system of claim 15, wherein the game server is configured to present the player with a listing of games to which the player is allowed access based on game access protection classification values of the listed games.

17. The system of claim 16, wherein a is the listed games are sorted based on the game access protection classification values.

18. The system of claim 16, wherein the listing of games excludes the at least one game.

19. The system of claim 15, wherein the game server is configured to allow the at least one player electronic access to a game that includes as a participant a second player with a player protection classification value different from that of the at least one player.

20. The system of claim 15, wherein the game server is configured to deny the at least one player electronic access to any game that includes as a participant a second player with a player protection classification value different from that of the at least one player.

21. The system of claim 15, wherein the at least one player protection classification value is indicative that the at least one player is a relatively low skilled player relative to at least one other player.

22. The system of claim 15, wherein the game is an electronic networked poker game.

23. The system of claim 22, wherein the game server is configure to provided electronic access to one of the games based on a determination of an electronic bankroll of the at least one player.

24. The system of claim 15, wherein the game server is configure to provide electronic access to the at least one game based on an electronic invitation associated with a second player having a game skill level value within a predetermined range of the at least one player.

25. The system of claim 15, wherein the game server is configured to provide access to the at least one game based on an electronic invitation associated with a second player having profile data in common with that of at least one player, the profile data selected from the group consisting of a language, geography, age, mutual friend, game type preferences, and time of day playing.

26. The system of claim 15, wherein the game server is configured to provide access to the at least one game is further provided based on a determination of at least one non-proficiency based factor selected from the group consisting of a playing style, reaction time, and player value.

27. The system of claim 15, wherein the game server is configure to provide access to the at least one game is based upon the range of values associated with the player protection category meets one or more of:
(a) the range of values associated within the game access protection category, and
(b) ranges within a plurality of game access protection categories.

28. The system of claim 15, wherein the game server is configured to allow electronic access to a game to which the at least one player would otherwise be denied access if an indication to not deny access to the game been received from the player.

29. An electronic game server for controlling access to a plurality of games in a skill-based electronic game network comprising:
a processor; and
computer readable memory coupled to the processor and storing instructions executed by the processor, said instructions causing the game server to allow or deny a player electronic access to a game based on a comparison of a player protection classification value of the player and a game protection classification value of the game.

30. An electronic poker game server for controlling access to a plurality of poker games in a skill-based electronic game network comprising:
a processor; and
a computer readable memory coupled to the processor and storing instructions executed by the processor, said instructions causing the server to (a) compare a player protection classification value of the player to respective game access values of the poker games, and (b) present the player with a listing of poker games in which the player will be allow to participate.
